(19) United States
(12) Patent Application Publication
(10) Pub. No.: US 2021/0223377 A1
(43) Pub. Date: Jul. 22, 2021

(54) METHOD AND DEVICE FOR GENERATING A RADAR SIGNAL, ASSOCIATED RADAR DETECTION METHOD AND SYSTEM

(71) Applicant: TDF, MONTROUGE (FR)

(72) Inventor: Pierre Kasser, BEUX (FR)

(73) Assignee: TDF, MONTROUGE (FR)

(21) Appl. No.: 17/273,091

(22) PCT Filed: Sep. 6, 2019
(86) PCT No.: PCT/FR2019/052049

§ 371 Date: Mar. 3, 2021

(30) Foreign Application Priority Data
Sep. 7, 2018 (FR) 1858055

(51) Int. Cl. G01S 13/00; G01S 7/00; G01S 13/06; G01S 7/28

(52) U.S. Cl. CPC G01S 13/003; G01S 7/28; G01S 13/06; G01S 7/006

(57) ABSTRACT

A method and a device for generating a radar signal are provided. The method includes a step of acquiring a communication signal comprising frames assigned to communication and frames not assigned to communication, and a step of inserting a radar pulse into at least one non-assigned frame of the communication signal, called radar frame, in order to form said radar signal.

### 1. TECHNICAL FIELD OF THE INVENTION

The invention relates to radar detection methods and systems. In particular, the invention relates to multistatic radar detection methods and systems.

### 2. TECHNOLOGICAL BACKGROUND

A radar detection system allows objects to be detected in a surveillance area, by using electromagnetic waves sent by a transmitter in the area. Electromagnetic waves that come into contact with an object in the surveillance area are reflected by this object, and this reflection is picked up by a receiver. The processing of the data received by the receiver can allow the features of the object to be determined, such as the position, speed, and nature thereof, etc. The objects detected are, for example, flying objects, such as aircraft, or sailing objects, such as ships.

Current radar systems are categorised into different categories on the basis of the component parts thereof: for example, a radar system is classified as monostatic if the transmitter of the radar system and the receiver of the radar system are connected to the same antenna, and thus to the same location. Conversely, a radar system is classified as multistatic if the one or more transmitters are connected to a different antenna and generally to a different location than the antenna of the receiver.

Two technologies are generally employed for multistatic radar systems: active radar systems and passive radar systems.

An active multistatic radar system uses one or more so-called cooperative transmitters, which transmit a specific radar signal towards the surveillance area, which is intended to be picked up by a receiver after reflection on the object to be detected. In particular, active multistatic radars procure good radar detection in the surveillance area thanks to the use of the specific radar signal, while at the same time increasing the discretion of the receiver since the location thereof cannot be detected because it does not transmit waves. On the other hand, the transmitters do not provide this discretion and the system is complex and costly to install, since it requires the installation of a comprehensive infrastructure dedicated to radar transmission and detection.

A passive multistatic radar system uses one or more so-called non-cooperative transmitters, which transmit, in a multitude of directions, a signal not originally intended for a radar detection application, e.g. a broadcasting or mobile phone signal. The receiver picks up these signals as well as the reflections of these signals by the object to be detected, and a processing operation is used to differentiate therebetween. Passive multistatic radars increase discretion since the only installation dedicated to the radar is the receiver, which does not transmit waves. On the other hand, the lack of control over the transmitted signal leads to a significant loss of accuracy compared to active radars, and the signals received require significant processing to be usable.

The two technologies thus mainly differ in the signals they generate and transmit towards the surveillance area: the active system uses a radar signal designed for radar detection, which is efficient but which makes the system detectable, and the passive system uses a signal not dedicated to radar, which makes the system undetectable but which is less efficient. A person skilled in the art is thus required to choose between these two types of signals depending on whether he/she is looking for high-performance or undetectable technology.

### 3. PURPOSES OF THE INVENTION

The invention aims to overcome at least some of the drawbacks of the known radar signals used in detection methods and systems.

In particular, the invention further aims to provide, in at least one embodiment of the invention, a method for generating a radar signal procuring a more efficient detection.

The invention further aims to provide, in at least one embodiment, a method for generating a radar signal guaranteeing a discrete radar detection method and system.

The invention further aims to provide, in at least one embodiment, a method for generating a radar signal that can be used thanks to simple and inexpensive adaptations of a pre-existing infrastructure.

The invention further aims to provide, in at least one embodiment, a method for generating a radar signal that allows the range of the transmitted radar signal to be extended, while improving the range resolution.

### 4. DISCLOSURE OF THE INVENTION

For this purpose, the invention relates to a method for generating a radar signal, characterised in that it comprises the following steps:
a step of acquiring at least one communication signal comprising frames assigned to the communication and frames not assigned to the communication,
a step of inserting a radar pulse into at least one frame not assigned to the communication of said at least one communication signal, referred to as a radar frame, in order to form said radar signal.

A generation method according to the invention thus makes it possible to generate a radar signal by integrating one or more radar pulses into unassigned frames of at least one communication signal, thus making it possible to combine the advantages of active and passive multistatic radars: said at least one communication signal used is adapted to contain communication information, for example radio communication information. Said at least one communication signal comprises frames not assigned to the communication, which are thus not used for communication purposes and are not taken into account by receiving equipment adapted to receive the communication signal. One or more unassigned frames are thus used to insert one or more radar pulses. These radar pulses procure a more efficient radar signal than a signal sent by a passive radar, since they are specifically adapted to radar use.

Moreover, the radar pulses are difficult to detect by an external system, which will recognise the entire communication signal without easily distinguishing the inserted radar pulse.

Use of a communication signal further allows pre-existing communication infrastructures to be used to transmit the radar signal thus obtained, and thus does not require implementing a dedicated infrastructure that is costly and complex to install.

Advantageously and according to the invention, the method for generating a radar signal comprises a step of obtaining an instruction to transmit a radar pulse which conditions said insertion step.

According to this aspect of the invention, the radar pulse is inserted into the communication signal to form the radar signal only if an instruction is obtained. This instruction allows the insertion of the radar pulse to be controlled as required within the scope of a radar detection, and optionally allows this insertion to be controlled remotely.

Advantageously and according to the invention, said instruction to transmit a radar pulse comprises one or more of the following features of the radar pulse:
the waveform of the radar pulse,
the occurrence and periodicity of the radar pulse,
the duration of the radar pulse,
the power of the radar pulse,
the duration of a silent period following the radar pulse.

According to this aspect of the invention, the instruction further allows for the setting of a multitude of parameters that the method for generating the radar signal must comply with; thus, for example, the power, shape, occurrence and duration of the radar pulse can be adapted as required within the context of a radar detection. Furthermore, the determination of the features of the radar pulse improves the detection thereof and makes it easier to distinguish between radar frames and frames assigned to the communication.

Advantageously and according to the invention, the method for generating a radar signal comprises a step of adding a header in at least one radar frame of said at least one radar signal, said header comprising information on the nature of the radar pulse.

According to this aspect of the invention, the header in particular makes it possible to warn any receiving equipment intended to use the frames assigned to the communication of the communication signal that the radar frames are not assigned to the communication, and that the data contained therein, in this case the radar pulse, must thus be disregarded. This ensures that the insertion of the radar pulses does not have any effect on the communications carried out via the communication signal.

Advantageously and according to the invention, said at least one communication signal acquired during said acquisition step is a signal using the communication protocol according to the DVB-T2 standard, for example compliant with the standard ETSI EN 302 755 V1.2.1, and the unassigned frames of said at least one communication signal are Future Extension Frame (FEF) type frames defined in said standard.

According to this aspect of the invention, the Future Extension Frames are frames provided for in the DVB-T2 broadcasting standard for future use in connection with, for example, an improvement to or an extension of the standard originally intended, for example, for mobile communication purposes. In this case, the method according to the invention takes advantage of these empty frames to insert a radar pulse, which has no connection with the broadcast, thus diverting these frames from the initial purpose thereof without any consequences for the initial communication service.

Alternatively, the communication standard considered is the American ATSC (Advanced Television Systems Committee) standard. In such a case, said at least one communication signal acquired during the acquisition step of the method according to the invention is a signal using the communication protocol according to the ATSC standard, in particular according to version 3.0. The unassigned frames of said at least one communication signal are similar to the FEFs (Future Extension Frames) of the DVB-T2 protocol. It should be noted that the ATSC 3.0 protocol is based on the physical layer of the DVB-T2 protocol.

According to another aspect of the invention, the radar pulse is inserted in at least one radar frame of a plurality of communication signals, each intended to be transmitted at a different frequency.

According to another feature of the invention, the radar pulse transmission instruction further comprises a frequency at which said at least one communication signal is intended to be transmitted.

According to another feature of the invention, after the step of inserting the radar pulse, the plurality of communication signals is multiplexed so as to form said radar signal.

According to another feature of the invention, the radar pulse is inserted for each signal of said plurality of communication signals with a delay specific to each signal.

According to another feature of the invention, the radar pulse is inserted for a given communication signal at a time Tn=TD+n.ΔT where ΔT designates a reference time interval and T0 designates a reference time common to said plurality of signals.

According to another feature of the invention, the reference time interval ΔT is zero.

According to another feature of the invention, the radar pulse is inserted for each signal intended to be transmitted at the frequency fn=f0+nΔf where Δf designates a reference frequency interval and n designates a natural number associated with said signal.

The invention further relates to a radar detection method, characterised in that it comprises:
a step of generating a radar signal in accordance with the generation method according to the invention,
a step of transmitting said generated radar signal,
a step of receiving the transmitted radar signal,
a step of extracting the radar pulse from the received radar signal.

The radar signal received during the step of receiving the transmitted radar signal is either directly the transmitted radar signal, or the radar signal transmitted and then reflected by any object located in a surveillance area, in which radar detection is implemented using the radar detection method.

The invention further relates to a device for generating a radar signal, characterised in that it comprises:
means for acquiring at least one communication signal comprising frames assigned to the communication and frames not assigned to the communication,
means for inserting a radar pulse into at least one frame not assigned to the communication of said at least one communication signal, referred to as a radar frame, in order to form said radar signal.

Advantageously, the method for generating a radar signal according to the invention is implemented by the device for generating a radar signal according to the invention.

Advantageously, the device for generating a radar signal according to the invention implements the method for generating a radar signal according to the invention.

According to one specific embodiment, the device for generating a radar signal according to the invention further comprises multiplexing means adapted to multiplex a plurality of communication signals, into which a radar pulse has been inserted by said insertion means, so as to form the radar signal.

The invention further relates to a radar detection system, characterised in that it comprises
at least one device for generating a radar signal according to the invention,
at least one transmitter adapted to transmit said radar signal generated by a device for generating a radar signal,
at least one receiver adapted to receive said radar signal transmitted by a transmitter,
means for extracting the radar pulse from the radar signal received by a receiver.

Advantageously, the radar detection method according to the invention is implemented by the radar detection system according to the invention.

Advantageously, the radar detection system implements the radar detection method.

According to one specific embodiment, the radar detection system according to the invention further comprises demultiplexing means for demultiplexing said radar signal received at the output of said at least one receiver into a plurality of communication signals from which the radar pulse is extracted by said extraction means.

The invention further relates to a method for generating a radar signal, a radar detection method, a device for generating a radar signal and a radar detection system, jointly characterised by all or part of the features disclosed hereinabove or hereinbelow.

### 5. LIST OF FIGURES

Other purposes, features and advantages of the invention will be better understood upon reading the following description which is not intended to limit the scope of the invention and given with reference to the accompanying figures, in which:

FIG. 1 is a diagrammatic view of the frames of a communication signal acquired according to one embodiment of the invention,

FIG. 2a shows a method for generating a radar signal according to one embodiment of the invention,

FIG. 2b shows a device for generating a radar signal according to one embodiment of the invention,

FIG. 3 is a diagrammatic view of a radar signal according to one embodiment of the invention,

FIG. 4 shows a radar detection method according to one embodiment of the invention,

FIG. 5 shows a radar detection device according to one embodiment of the invention,

FIG. 6 shows a device for generating a radar signal according to one embodiment of the invention using the DVB-T2 standard,

FIG. 7 diagrammatically shows the insertion of a radar pulse into a set of communication signals intended to be multiplexed before transmission.

### 6. DETAILED DESCRIPTION OF ONE EMBODIMENT OF THE INVENTION

The following embodiments are examples. Although the description refers to one or more embodiments, this does not necessarily mean that each reference relates to the same embodiment, or that the features apply only to a single embodiment. Simple features of different embodiments can also be combined in order to provide other embodiments.

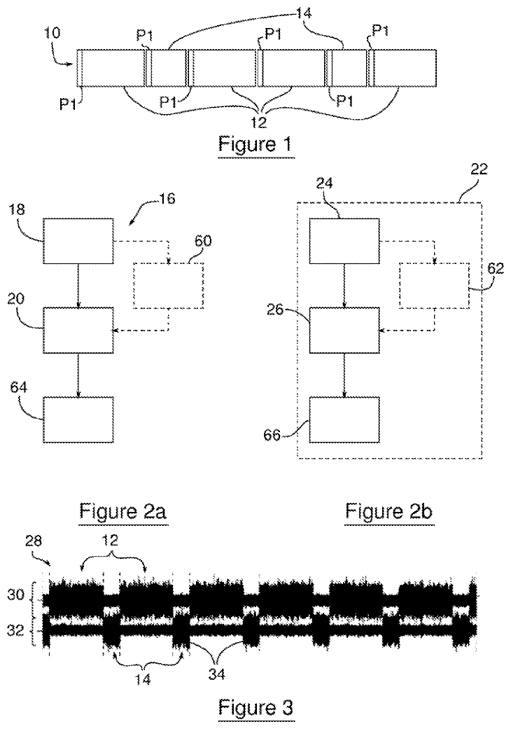

FIG. 1 diagrammatically shows a communication signal 10 comprising frames 12 assigned to the communication and frames 14 not assigned to the communication. In this case, the communication signal 10 shown is a signal according to the DVB-T2 standard. The frames 12 assigned to the communication are referred to as “T2 frames” according to said standard, whereas the frames 14 not assigned to the communication are, for example, “Future Extension Frame” (FEF) type frames defined in said standard. These FEFs 14 are present in the standard to anticipate evolutions thereto, by proposing empty frames that can be used in a possible extension of the standard. The P1 symbols preceding each frame make it possible to distinguish the nature of the T2 frames and FEFs as well as the parameters thereof.

The invention consists of a method 16 for generating a radar signal using the frames not assigned to the communication of a communication signal, for example the FEFs 14 of the DVB-T2 type communication signal 10, to insert radar pulses therein. As shown in FIG. 2a, the method 16 for generating the radar signal comprises a step 18 of acquiring the communication signal 10 comprising the frames 12 assigned to the communication and the frames 14 not assigned to the communication, such as the DVB-T2 signal shown in FIG. 1, and a step 20 of inserting a radar pulse into at least one unassigned frame 14 of the communication signal, referred to as a radar frame, in order to form said radar signal. The radar frame thus designates an unassigned frame 14 into which a radar pulse has been inserted.

The method 16 for generating a radar signal is advantageously implemented by a device 22 for generating the radar signal, shown in FIG. 2b, comprising means 24 for acquiring the communication signal 10 comprising the frames 12 assigned to the communication and the frames 14 not assigned to the communication, and means 26 for inserting a radar pulse into at least one unassigned frame 14 of the communication signal, referred to as a radar frame, in order to form said radar signal. The acquisition means 24 and the insertion means 26 of the device for generating a radar signal are, for example, modules embedded in an electronic control unit, a computer, or more particularly a DVB-T2 modulator which can be assigned to other tasks, in particular to processing the communication signal before the acquisition thereof and to processing the radar signal once it has been generated. The modules can be present in the electronic control unit, the computer or the DVB-T2 modulator in hardware or software form or in a combination of software and hardware means.

One example of a radar signal resulting from the method for generating the radar signal is shown in FIG. 3. The radar signal 28 is shown separated into two parts to improve visibility, a communication part 30 of the radar signal 28 and a purely radar part 32 of the radar signal 28. In the communication part 30 of the radar signal 28, the difference between the frames 12 assigned to the communication and the frames 14 not assigned to the communication is easily visible: during the assigned frames 12 of the communication signal, a modulation of the communication part 30 of the radar signal 28 is seen, allowing information to be transmitted. During the frames 14 not assigned to the communication, the communication part 30 of the radar signal 28 has a minimum, constant value and is not modulated: it does not contain any communication information. The method 16 for generating the radar signal described in FIG. 2a thus allows additional information to be inserted into these frames 14 not assigned to the communication, the additional information being, in this case, the radar pulses 34 represented in the purely radar part 32 of the radar signal 28. In contrast to the communication part 30 of the radar signal 28, the purely radar part 32 of the radar signal 28 only comprises the modulated information-carrying signal, i.e. the radar pulses 34, in the unassigned frames 14 of the signal. As shown in FIG. 3, these radar pulses 34 of the purely radar part 32 of the radar signal 28 have a duration that is generally shorter than the frames 12 assigned to the communication.

In practice, the communication part 30 of the signal and the purely radar part 32 of the radar signal 28 are grouped together and optionally only separated after processing the radar signal 28, for example when receiving the radar signal 28.

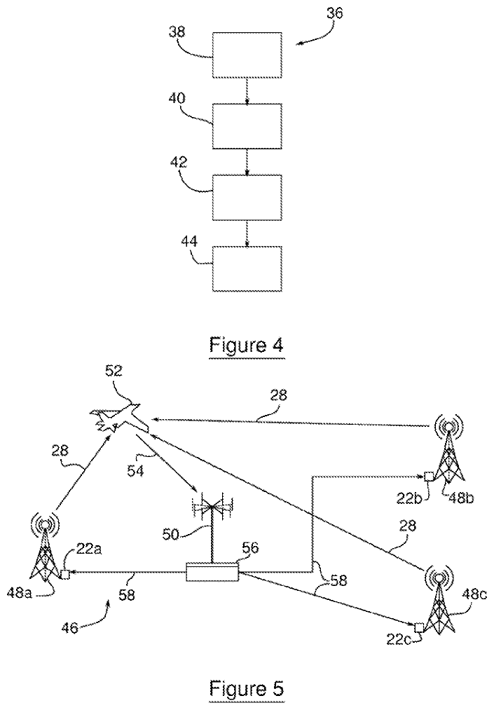

FIG. 4 shows a radar detection method 36 allowing, for example, for the surveillance of an area and the detection of objects liable to move therein, as well as the detection of features of these objects, such as the position thereof, the speed thereof, and the nature thereof, etc.

The radar detection method 36 comprises:
a step 38 of generating the radar signal according to the signal generation method 16 according to the invention described hereinabove with reference to FIG. 2a,
a step 40 of transmitting the radar signal, for example by means of one or more transmitters,
a step 42 of receiving the radar signal, for example by a receiver,
a step 44 of extracting the radar pulse from the radar signal.

The radar detection method 36 is, for example, implemented by a radar detection system 46 as shown in FIG. 5.

The radar detection system 46 is a multistatic radar system, comprising at least one transmitter, in this case three transmitters 48a, 48b, 48c, which are placed on antennas and at different locations from one another and from a receiver 50. The radar detection system 46 further comprises at least one device 22 for generating a radar signal implementing the method 16 for generating a radar signal according to the invention. In this case, each transmitter 48a, 48b, 48c comprises a device 22a, 22b, 22c for generating a radar signal and is adapted to transmit the radar signal 28 generated by the device 22a, 22b, 22c thereof for generating a radar signal during the step of generating the radar signal of the radar detection method. In another embodiment not shown, the radar signal can be generated by a single radar signal generation device and then transmitted to all transmitters in order to be transmitted.

The radar signal 28 transmitted by the transmitters, during the step of transmitting the radar signal of the radar detection method, in the surveillance area allows an object, in this case an aircraft 52, passing through this area, to be detected by the reflection of the radar signal 28 on the aircraft 52 and the receipt by the receiver 50 of a reflected radar signal 54. The receiver 50 also generally directly receives the radar signal 28 transmitted by one of the transmitters 48a, 48b, 48c.

Means 56 for extracting the radar pulse from the radar signal allow the radar pulse of the reflected radar signal 54 to be processed in order to determine the presence of an object and potentially the position thereof, the speed thereof, the direction of travel thereof, and the nature thereof, etc.

In order to improve the performance of the radar detection, the receiver 50 must be able to easily isolate the radar pulse from the radar signal. The radar pulses can thus be controlled by the receiver 50, for example by generating a radar pulse transmission instruction 58 and by transmitting this radar pulse transmission instruction 58 to each transmitter 48a, 48b, 48c. This radar pulse transmission instruction 58 allows several parameters or features of the radar pulse to be controlled, in particular:
the waveform of the radar pulse,
the occurrence and the periodicity of the radar pulse,
the duration of the radar pulse,
the duration of the silent period following the pulse allowing the echo reflected by the target to be taken into account,
etc.

These features, in particular the waveform and the duration of the radar pulse, make it possible to generate a radar signal 28, the radar pulse whereof is adapted in the frame to minimally disrupt the original communication signal into which said pulse is inserted, and in particular the useful throughput of said original communication signal.

Moreover, the device 22 for generating the signal can be configured not to insert a radar pulse into the communication signal, if it does not obtain a radar pulse transmission instruction 58, for example, if the surveillance area is not currently being surveilled. This allows the communication signal to remain unchanged if no radar detection is required. With reference to FIG. 2a, a step 60 of obtaining a radar pulse transmission instruction allows the instruction to be taken into account in the method for generating the radar signal. With reference to FIG. 2b, this obtaining step is implemented by means 62 for obtaining a radar pulse emission instruction.

The modification of the communication signal can also be obtained by sending the instruction 58 using the occurrence and periodicity features, using a limited number of unassigned frames, for example every other frame, if the use of every unassigned frame is not necessary.

The transmitters 48a, 48b, 48c used in the radar detection system 46 are originally transmitters intended to transmit communication signals to communication signal receiving equipment (not shown). In this case, the transmitters 48a, 48b, 48c are originally intended for the transmission of the communication signal 10, acquired during the acquisition step 18 of the method 16 for generating the radar signal, to the receiving equipment. Thus, within the scope of the radar detection method 16, this transmission must be carried out without disruption as regards the receiving equipment, in other words the method 16 for generating a radar signal modifies the communication signal 10 to form the radar signal 28 which is transparent to the receiving equipment.

For this purpose, the one or more unassigned frames 14 into which a radar pulse has been inserted, referred to as radar frames, comprise a header (otherwise known as a preamble) comprising information on the nature of the signal immediately following, in this case the radar pulse, and in particular indicating to the receiving equipment that it must not take into account said radar frames because they do not contain communication information, said information being present only in the frames 12 assigned to the communication. This header present at the beginning of each radar frame is either present at the offset if the protocol or standard provides for such, or is added during a step 64 of adding a header in the radar frame of the method for generating a radar signal, as shown with reference to FIG. 2a. According to another embodiment, this addition step can be carried out before the step 20 of inserting the radar pulse. This addition step is implemented, for example, by means 66 for adding a header of the signal generating device 22, as shown with reference to FIG. 2b. For example, in the DVB-T2 standard described in the standard document ETSI EN 302 755 V1.2.1, the FEFs are indicated in the P1-type header, which is common to all frame types, but the value whereof allows the assigned frames to be differentiated from the FEFs. These P1 headers are, for example, shown with reference to FIG. 1. A receiver device reading a header indicating the presence of a FEF thus will not consider the FEF following the header. In practice, a P1 frame according to the DVB-T2 standard comprises two words, a first three-bit S1 word and a second four-bit S2 word. In this embodiment, the P1 header indicates a FEF that must not be read by receiving equipment when the first S1 word comprises the value “010” indicating the presence of non-T2 frames, and the second S2 word comprises the value “0001” indicating that the P1 header is a FEF header and that the signal comprises other types of P1 headers, in particular the headers of T2 frames assigned to the communication. Another type of header, referred to as a P2 header, is present only in the T2 frames assigned to the communication. It nonetheless comprises information related to the FEFs not assigned to the communication, including via an L word comprising variables indicating the type of FEF (FEF_TYPE), the occurrence interval between two FEFs (FEF_INTERVAL), and the length of the FEFs (FEF_LENGTH). More specifically, the occurrence interval between two frames is defined by the number of T2 frames between two FEFs.

According to one embodiment of the invention, if the communication signal used is a signal according to the DVB-T2 standard, it can be configured such that the throughput thereof is 33.1 Mbps (megabits per second), and such that the duration of a frame assigned to the communication is 243.9 ms. In order to keep disruption to the communication signal throughput to a minimum, the frames not assigned to the communication have, for example, a duration of about 1.1 ms. The frames not assigned to the communication thus result in a reduced throughput of 33.1*1.1/243.9=150 kbps (kilobits per second) compared to a communication signal solely comprising frames assigned to the communication, which represents about 0.5% loss, which is negligible.

Since the P1 header lasts 224 μs, the time remaining in the frames not assigned to the communication to insert the radar pulse is 876 μs. The radar pulse is generally followed by a silent period, during which the radar pulse can be received after reflection of said radar pulse on the object in the surveillance area. For a radar pulse with a duration of several microseconds, for example 10 μs, the duration of the silent period is 876-10=866 μs, thus allowing the pulse to travel c*866*10⁴=260 km, where c designates the propagation speed of the radar signal, approximately equal to 300,000 km/s, i.e. a radar detection range of 260/2=130 km.

According to one embodiment of the invention, the transmitters 48a, 48b, 48c of the detection system form a part of a so-called single-frequency network (SFN), i.e. the transmitters 48a, 48b, 48c transmit all signals at the same frequency and with synchronised timing. According to another embodiment of the invention, a site can transmit a plurality of radar signals with different frequencies on a plurality of transmitters, thus procuring a so-called pseudo-wideband transmission, the radar pulse being transmitted synchronously in the slot of the radar signal N times, where N is the number of different frequencies used on a given site. This embodiment allows phase and amplitude summation of the individual pulses for high instantaneous power and achieves a better frequency diversity and a better echo separation resolution. The implementation of this embodiment requires perfect synchronisation of the transmission times of the FEFs of each initial signal.

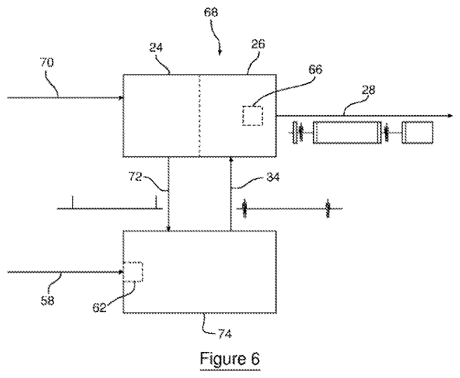

FIG. 6 shows a device for generating a radar signal according to one embodiment of the invention using the DVB-T2 standard. The acquisition means 24 and the insertion means 26 are embedded in a DVB-T2 modulator 68. The DVB-T2 modulator 68 receives the communication signal, in the form of a stream 70 referred to as a T2-M stream, comprising the communication data to be transmitted for the communication with the equipment for receiving the communication signal. Once the signal has been received, the DVB-T2 modulator 68 transmits a synchronisation signal 72 indicating to a radar pulse generator 74 at what moment the radar pulses can be generated for insertion into the frames not assigned to the communication. The radar pulse generator 74 comprises the means 62 for obtaining a radar pulse transmission instruction 58, said instruction 58 originating, for example, as described with reference to FIG. 5, from the receiver 50. The radar pulse generator 74 generates a radar pulse 34 taking into account the radar pulse features contained in the instruction 58, synchronises the radar pulses 34 in accordance with the received synchronisation signal 72, and transmits the radar pulses 34 to the DVB-T2 modulator 68. The insertion means 26 insert the radar pulse into the frames not assigned to the communication of the communication signal in order to form said radar signal 28. Means 66 for adding a header add the suitable headers to the radar signal 28 as described hereinabove. The radar signal 28 is then transmitted, for example, to an amplifier (not shown) so that it is transmitted by the transmitters 48a, 48b, 48c.

The invention is not limited solely to the embodiments described. In particular, types of communication signals other than DVB-T2, such as ATSC 3.0, can be used, as long as they allow for the use of a frame not assigned to the communication, either because it is never assigned or because the assignment thereof can be modified without jeopardising the original communication: more particularly, any unassigned frame can be used if equipment for receiving the communication signal for which the communication signal is intended detects that the radar frame is not intended therefor and does not take it into account.

According to one specific embodiment, communication signals compliant with the ATSC standard, in particular version 3.0 thereof released in October 2017, are used. In such a case, the frames not assigned to the communication of the communication signal are similar to the FEFs (Future Extension Frames) of the DVB-T2 protocol.

The choice of the communication signals used and thus of the associated transmitters is made according to different parameters, for example, the coverage of the surveillance area: in such a case, the transmitters of communication signals covering as much of the surveillance area as possible are preferred, these signals being, for example, radiophony- or television-type broadcasting signals, or signals from mobile telephone networks, these example signals being already extensively developed and covering large areas.

In order to increase the power of the radar signal while improving the range resolution thereof, the inventors propose taking advantage of the multiplexing of the communication signals, such as those transmitted within the scope of the Digital Terrestrial Television (DTT) broadcasting service, for example according to the DVB-T standard.

In a known manner, each digital video signal of a television channel is supplied to a multiplex operator who is responsible for assembling the compressed streams of a plurality of channels into the same channel corresponding to a range of frequencies in order to form a multiplex, compliant with, for example, the DVB-T2 standard. Currently in France, there are six “multiplexes” in the DVB-T standard, allowing about thirty programmes or TV channels to be transmitted simultaneously.

According to one specific embodiment, the radar signal 28′ is a multiplex as defined hereinabove. It comprises a plurality of communication signals 10.0, 10.1, 10.2. Each of these signals is transmitted or received at a different frequency, designated by f0, f1, f2 respectively. For example, the three signals 10.0, 10.1, 10.2. form a multiplex carrying three television channels. This multiplex is transmitted in the same transmission channel comprised in a given frequency band.

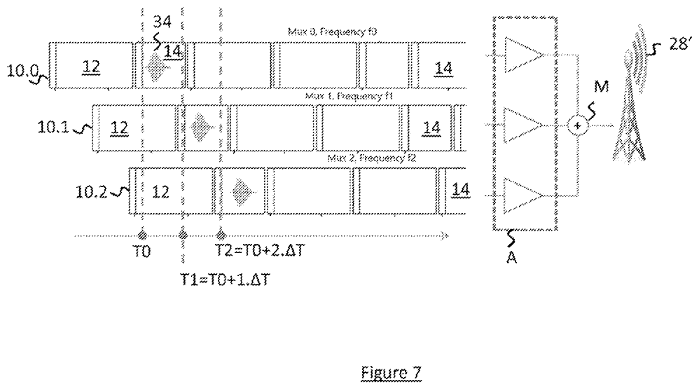

FIG. 7 diagrammatically shows the insertion of a radar pulse 34 into three of the communication signals 10.0, 10.1, 10.2 intended to be multiplexed before transmission according to this other specific embodiment.

As described hereinabove with reference to FIG. 1, each communication signal 10.0, 10.1, 10.2 comprises frames 12 assigned to the communication and frames 14 not assigned to the communication. This involves inserting a radar pulse into these unassigned frames 14.

According to this specific embodiment, the radar pulse 34, as described hereinabove, is synchronously inserted into frames 14 not assigned to the communication of the signals 10.0, 10.1, 10.2.

Synchronous insertion means that the radar pulse is transmitted according to a time base common to each signal. In other words, the radar pulse can be inserted at times Tn that are defined in a manner common to each signal. For example, Tn=TD+n.ΔT is defined, where n designates a natural number that can be zero and ΔT designates a predefined reference time interval. Thus, the radar pulse 34 can only be inserted occasionally at the predefined times Tn.

In general, the radar pulse 34 is inserted into the n^{th} signal 10.n, at the time Tn=T0+n.ΔT, in a frame not assigned to the communication, for example in a FEF 14 in the case whereby the signal complies with the DVB-T2 standard. According to the example shown in FIG. 7, the radar pulse 34 is successively inserted at the times T0=TD+0.ΔT, T1=T+1.ΔT and T2=TD+2.ΔT respectively in the first 10.0, second 10.1 and third 10.2 signals.

In general, the frequency fn of the n^{th} signal 10.n, into which the radar pulse 34 is inserted, is such that fn=f0+n.Δf where n designates a natural number and Δf designates a reference frequency interval.

According to the example shown in FIG. 7, the respective frequencies of the signals 10.0, 10.1, 10.2 are such that f0=f0+0.Δf, f1=f0+1.Δf and f2=f0+2.Δf.

Thus, the radar pulse 34 is inserted into each signal 10.0, 10.1, 10.2 with a predefined delay which is specific to the signal considered, respectively 0, ΔT, 2ΔT relative to the common time reference T0.

Each signal 10.0, 10.1, 10.2 is intended to be transmitted at a frequency f0, f1, f2 respectively. All of these three signals are multiplexed so as to form a multiplex intended to be sent in the same channel. This multiplex forms the radar signal 28′.

Generally speaking, the radar signal 28′ thus obtained is a composite signal comprising a set of n radar pulses temporally distributed across n signals 10.0 to 10.n−1 of different frequencies within the same transmission channel.

At each transmission cycle, the radar signal 28′ is seen as a multi-frequency composite signal comprising a plurality of radar pulses, each of these pulses being carried at a different frequency comprised within the bandwidth of the transmission channel.

This transmission channel can be previously identified by the frequency (f0; f1; f2) at which of a carrier channel into which the radar pulse is intended to be transmitted. This frequency is inserted into the transmission instruction 58 described hereinabove.

It follows herefrom that the cumulated power of the radar pulses per transmission cycle increases as the number of signals used to transmit the radar pulses increases. This advantageously allows the propagation distance of the transmitted radar signal to be increased, and thus the range of the radar to be extended.

Another advantage of such a composite radar signal is that it substantially improves the radar range resolution compared to the case whereby the radar pulse is inserted on a single-frequency signal.

If a single-frequency signal is used, the radar resolution Rs depends on the duration τ of the radar pulse according to the following formula: Rs=c*τ/2 where c designates the speed of light in a vacuum equal to 3.10⁸ m/s. In such a case, improving the resolution requires reducing the duration of the radar pulses.

If a composite signal according to the invention as described hereinabove is used, the resolution becomes: Rs=c/(2.n.Δf) where n designates the number of signals of different frequency, into which the radar pulse 34 has been inserted. In such a case, the resolution no longer depends on the duration t of the radar pulses, but on the number of signals used (i.e. the number of frequency components making up the composite signal) and on the frequency step Δf defined between two consecutive frequencies. Thus, the resolution can be substantially improved by increasing the number of channels into which the radar pulse is inserted and/or by increasing the frequency step.

For example, considering pulses having a duration equal to 1 μs, the radar resolution is 150 m in the case whereby the radar pulse is inserted at a single frequency (i.e. on a single-frequency signal) whereas this resolution is advantageously reduced to 4.6 m in the case of a signal comprising 4 frequency components, i.e. n=4.

Thus, the main advantage of this embodiment is that it substantially improves the radar resolution (i.e. minimises the Rs parameter) in exchange for a limited pulse power and a longer processing time.

Once the radar pulse 34 has been inserted into frames not assigned to the communication of the different signals 10.0, 10.1, 10.2, these are multiplexed in order to form the radar signal 28′ before it is transmitted.

In the present example, the signals are multiplexed in compliance with the DVB-T2 standard, for example by a DVB-T2 transmitter comprising multiplexing means compliant with the DVB-T2 standard. In general, any other known multiplexing technique allowing different signals comprising the radar pulses to be combined within the scope of the present invention can be considered as a function of the standard used.

Before being multiplexed, all or part of the communication signals into which the radar pulse 34 has been inserted can be amplified by means of an amplification stage A as shown in FIG. 7. For example, the amplification stage comprises a plurality of radio frequency amplifiers.

The coordinated emission of radar pulses at a predefined rate Tn=T0+nΔT and at predefined frequencies fn=f0+nΔf as described hereinabove according to one aspect of the invention improves the resolution and the ambiguity function of the radar, where n designates an integer. This is particularly advantageous for effectively separating close targets or for distinguishing a target from interference caused by radar wave reflections on the ground or on obstacles (e.g. raised terrain or buildings).

According to one alternative embodiment not shown, the radar pulse 34 is inserted at the same reference time Tm into a frame not assigned to the communication of all or part of the communication signals. This alternative embodiment can be seen as a specific case of the embodiment described hereinabove, where the delay ΔT is zero. For example, Tn=TD+n.ΔT where ΔT=0. In such a case, it can be decided to insert the radar pulse at the same time T0 into the frames not assigned to the communication of the different signals. This operation can be repeated at regular time intervals, e.g. Tm=m.T0 where m is a non-zero natural number.

This alternative embodiment advantageously maximises the power of the radar signal by transmitting the same pulse simultaneously at different frequencies (i.e. in different signals at different frequencies within the same channel). This increases the range of the radar.

When receiving, the radar detection system described hereinabove with reference to FIG. 5 remains valid, however further comprises demultiplexing means (not shown) for demultiplexing the composite radar signal 28′ received at the output of said at least one receiver 50. The demultiplexing means are adapted to demultiplex the received composite radar signal into a plurality of communication signals from which the radar pulse 34 is extracted by said extraction means 56. These demultiplexing means can be comprised in a detector compliant with the DVB-T2 or ASCT 3.0 standard, or any other similar standard.

1. A method for generating a radar signal, comprising the steps of:
acquiring at least one communication signal comprising frames assigned to the communication and frames not assigned to the communication, and
inserting a radar pulse into at least one frame not assigned to the communication of said at least one communication signal, referred to as a radar frame, in order to form said radar signal.

2. The method for generating a radar signal according to claim 1, further comprising the step of obtaining an instruction for transmitting a radar pulse which conditions said insertion step.

3. The method for generating a radar signal according to claim 2, wherein said radar pulse transmission instruction comprises at least one of the following radar pulse features:
a waveform of the radar pulse,
a occurrence and periodicity of the radar pulse,
a duration of the radar pulse,
a power of the radar pulse, and
a duration of a silent period following the radar pulse.

4. The method for generating a radar signal according to claim 1, further comprising the step of adding a header (P1) in at least one radar frame of the radar signal, said header comprising information on the nature of the radar pulse.

5. The method for generating a radar signal according to claim 1, wherein said at least one communication signal acquired at said acquisition step is a signal using the communication protocol according to the DVB-T2 standard, and the frames not assigned to the communication of said at least one communication signal are frames of the Future Extension Frame type defined in said standard.

6. The method for generating a radar signal according to claim 1, wherein said at least one communication signal acquired in said acquisition step is a signal using the communication protocol according to the ATSC 3.0 standard.

7. The method for generating a radar signal according to claim 1, wherein the radar pulse is inserted into at least one radar frame of a plurality of communication signals, each being configured to be transmitted at a different frequency.

8. The method according to claim 3, wherein said radar pulse transmission instruction further comprises a frequency at which said at least one communication signal is configured to be transmitted.

9. The method for generating a radar signal according to claim 8, wherein after the step of inserting the radar pulse, the plurality of communication signals are multiplexed to form said radar signal.

10. The method for generating a radar signal according to claim 7, wherein said radar pulse is inserted for each signal of said plurality of communication signals with a delay specific to each signal.

11. The method for generating a radar signal according to claim 10, wherein the radar pulse is inserted for a given communication signal (10.n) at a time Tn=T0+n.ΔT where ΔT designates a reference time interval and T0 designates a reference time (T0) common to said plurality of signals.

12. The method for generating a radar signal according to claim 11, wherein the reference time interval ΔT is zero.

13. The method for generating a radar signal according to claim 7, wherein the radar pulse is inserted for each signal (10.n) intended to be transmitted at the frequency fn=f0+Δf where Δf designates a reference frequency interval and n designates a natural number associated with said signal.

14. A radar detection method, comprising the steps of:
generating a radar signal in accordance with the generation method according to claim 1,
transmitting said generated radar signal,
receiving the transmitted radar signal, and
extracting the radar pulse from the received radar signal.

15. A device for generating a radar signal, comprising:
means for acquiring at least one communication signal comprising frames assigned to the communication and frames not assigned to the communication, and
means for inserting a radar pulse into at least one frame not assigned to the communication of said at least one communication signal, referred to as a radar frame, in order to form said radar signal.

16. The device for generating a radar signal according to claim 15, further comprising multiplexing means adapted to multiplex a plurality of communication signals, into which a radar pulse has been inserted by said insertion means, to form the radar signal.

17. A radar detection system, comprising:
at least one device for generating a radar signal according to claim 15,
at least one transmitter adapted to transmit said radar signal generated by a device for generating a radar signal,
at least one receiver adapted to receive said radar signal transmitted by a transmitter, and
means for extracting the radar pulse from the radar signal received by a receiver.

18. The radar detection system according to claim 17, further comprising demultiplexing means for demultiplexing said radar signal received at the output of said at least one receiver into a plurality of communication signals from which the radar pulse is extracted by said extraction means
